(19) United States
(12) Patent Application Publication
(10) Pub. No.: US 2021/0250553 A1
(43) Pub. Date: Aug. 12, 2021

(54) VEHICLE MIRROR RECORDING SYSTEM

(71) Applicant: Jose Henry Naber, JR., Mebane, NC (US)

(72) Inventor: Jose Henry Naber, JR., Mebane, NC (US)

(21) Appl. No.: 16/786,511

(22) Filed: Feb. 10, 2020

(51) Int. Cl. H04N 7/18; H04N 5/77; B60R 1/12; B60R 11/02; B60R 25/30; B60R 25/10; B60R 16/033; B60R 25/102

(52) U.S. Cl. CPC H04N 7/188; H04N 5/77; H04N 7/181; B60R 1/12; B60R 11/0247; B60R 25/305; B60R 2011/0043; B60R 16/033; B60R 25/302; B60R 25/102; B60R 2001/1253; B60R 2001/1223; B60R 25/1004

(57) ABSTRACT

The presently disclosed subject matter is generally directed to an audio and/or video recording system configured within a vehicle rear-view and/or side-view mirror. Advantageously, the disclosed system is configured to record criminal incidents and/or provide evidence after a wreck or other driving event has occurred. The vehicle mirror includes a front face comprising a reflective surface that is operably attached to a rear body. The mirror interior houses at least one camera capable of recording an event, such as a vehicle break-in. The camera spans at least one surface of the rear-view mirror, such that the camera lens is present on the mirror exterior. Because the majority of camera and associated electronics are housed within the vehicle interior, the perpetrator is unaware that he is being recorded.

### TECHNICAL FIELD

The presently disclosed subject matter is generally directed to a recording system for use with a vehicle. More specifically, the disclosed system includes one or more recording devices incorporated within the vehicle rear-view mirror and/or side-view mirrors.

### BACKGROUND

Crimes involving vehicles are a worldwide problem. Particularly, vehicle theft, burglary, and vandalism result in considerable inconvenience, damage, and financial loss for both the vehicle owner and insurer. As a result, a variety of security devices have been developed to deter such crimes. Traditional car alarms function by emitting a loud siren or horn when a vehicle intrusion or disturbance occurs (e.g., when a car window is broken or a car door is forced open). After the alarm sounds, the perpetrator typically flees without doing further damage to the vehicle. However, the intruder is not identified and thus is not prevented from performing similar crimes to other vehicles. Remotely operable systems for disabling vehicles are also commonly used to deter crimes. However, vehicle thieves have conceived various ways to disable or circumvent the systems. Such remotely operable systems also do not enable the identification of the perpetrator. It would therefore be beneficial to provide a system that overcomes the shortcomings of the prior art by preventing harm and/or theft of a vehicle, while also identifying the criminal.

### SUMMARY

In some embodiments, the presently disclosed subject matter is directed to a vehicle recording system comprising a vehicle mirror assembly. The vehicle mirror assembly is defined by a front face comprising a reflective material, and a rear body that releasably attaches to the front face, creating an interior therebetween. The interior comprises at least one camera for automatically capturing an image external to the vehicle mirror, wherein each camera includes a body that is maintained within the interior and a lens that extends at least partially through a portion of the front face or rear body. The interior further includes a printed circuit board electrically coupled to the at least one camera, a central processing unit installed on the printed circuit board and electrically coupled to the camera, a memory installed on the printed circuit board, electrically coupled to the central processing unit for storing image data received from the camera, and a mobile network connection module installed on the printed circuit board and electrically coupled to the central processing unit, and connected to a remote reporting data center via a signal by a wireless network signal connection.

In some embodiments, the vehicle recording system further comprises a microphone installed on the printed circuit board, electrically coupled to the central processing unit.

In some embodiments, the front face or rear face includes an initiator that can activate recording of the at least one camera.

In some embodiments, the vehicle recording system further comprises an indicator light visible from the exterior of the assembly to indicate when the at least one camera is recording.

In some embodiments, the camera comprises a sensor that initiates recording upon the occurrence of a triggering event. In some embodiments, the triggering event comprises the activation of a vehicle alarm, motion detection, an increased noise level, or combinations thereof.

In some embodiments, the vehicle mirror assembly is selected from a rear-view mirror, a side-view mirror, or combinations thereof.

In some embodiments, the vehicle recording system further comprises a battery installed on the printed circuit board, electrically coupled to the central processing unit.

In some embodiments, the presently disclosed subject matter is directed to a method of recording a triggered event within a vehicle or exterior to a vehicle. Specifically, the method comprises activating a vehicle recording system comprising a vehicle mirror assembly. The vehicle mirror assembly defined by a front face comprising a reflective material, and a rear body that releasably attaches to the front face, creating an interior therebetween. The interior comprises at least one camera for automatically capturing an image external to the vehicle mirror, wherein each camera includes a body that is maintained within the interior and a lens that extends at least partially through a portion of the front face or rear body. The interior further includes a printed circuit board electrically coupled to the at least one camera, a central processing unit installed on the printed circuit board and electrically coupled to the camera, a memory installed on the printed circuit board, electrically coupled to the central processing unit for storing image data received from the camera, and a mobile network connection module installed on the printed circuit board and electrically coupled to the central processing unit, and connected to a remote reporting data center via a signal by a wireless network signal connection. The method further includes initiating recording of the at least one camera to capture an area external to the mirror assembly after a triggering event occurs, transmitting the at least one camera recording to a location, and saving the recording. The triggered event within a vehicle or exterior to a vehicle is recorded.

In some embodiments, the activating is defined by activating an initiator positioned on the front face or rear face of the vehicle mirror assembly.

In some embodiments, the vehicle mirror assembly further includes an indicator light visible from the exterior of the assembly to indicate when the at least one camera is recording.

In some embodiments, the vehicle mirror assembly is configured as a rear-view mirror, a side-view mirror, or combinations thereof.

In some embodiments, the triggering event comprises the activation of a vehicle alarm, motion detection, an increased noise level, or combinations thereof.

In some embodiments, the transmitting comprises a wireless transmission.

In some embodiments, the at least one camera is hidden from view from the interior or exterior of the vehicle.

In some embodiments, the triggered event is a vehicle crime. In some embodiments, the crime is selected from vehicle theft, car jacking, vehicle vandalism, abuse within or exterior to a vehicle, and vehicle accidents.

In some embodiments, the recording occurs for a predetermined amount of time.

In some embodiments, the transmitting location is selected from the vehicle owner's phone, computer, law enforcement, or combinations thereof.

In some embodiments, the recording is saved for a predetermined amount of time.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1a is a front plan view of a rear-view mirror housing a recording system in accordance with some embodiments of the presently disclosed subject matter.

FIG. 1b is a side plan view of the rear-view mirror of FIG. 1a.

FIG. 1c is a fragmentary view illustrating a camera used in accordance with some embodiments of the presently disclosed subject matter.

FIG. 2a is a front plan view of a side-view mirror housing a recording system in accordance with some embodiments of the presently disclosed subject matter.

FIG. 2b is a top plan view of the side-view mirror of FIG. 2a.

FIG. 3 is a top plan view of a printed circuit board that can be used in accordance with some embodiments of the presently disclosed subject matter.

FIG. 4a is a perspective view illustrating an interior of a recording system in accordance with some embodiments of the presently disclosed subject matter.

FIG. 4b is a perspective view of a memory card that can be used in accordance with some embodiments of the presently disclosed subject matter.

FIG. 4c is a perspective view illustrating one embodiment of a recording system in accordance with the presently disclosed subject matter.

FIG. 4d is a perspective view illustrating one embodiment of a recording system in accordance with some embodiments of the presently disclosed subject matter.

FIG. 5 is a schematic illustrating one method of using the disclosed recording system.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

The presently disclosed subject matter is generally directed to a system that includes one or more audio and/or video recording devices configured within a vehicle rear-view and/or side-view mirror. The term “vehicle” as used herein broadly refers to any conveyance designed for the purpose of moving people, animals, cargo, and the like. Suitable vehicles can therefore include cars, trucks, buses, tractor trailers, motorcycles, mopeds, boats, school buses, emergency vehicles, trains, RVs, and the like). Advantageously, the disclosed system is configured to record criminal incidents and/or provide visual and audible evidence after a wreck or other driving event has occurred.

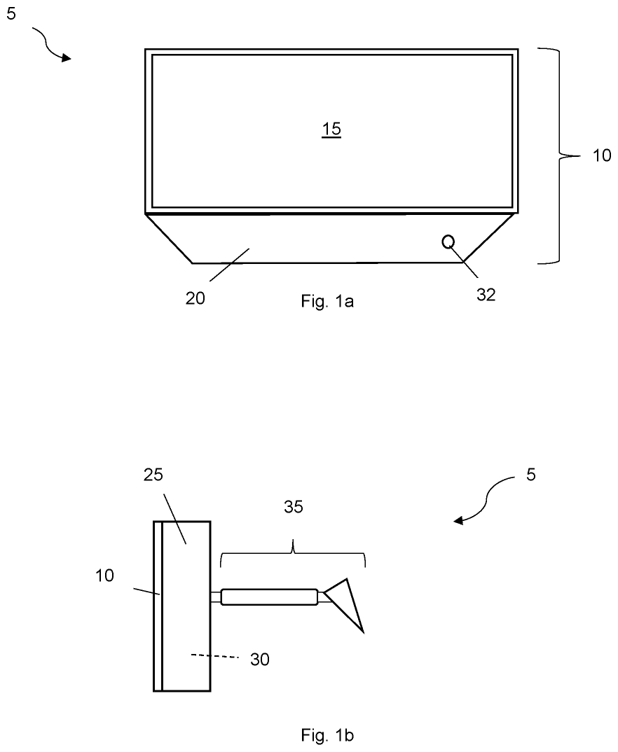

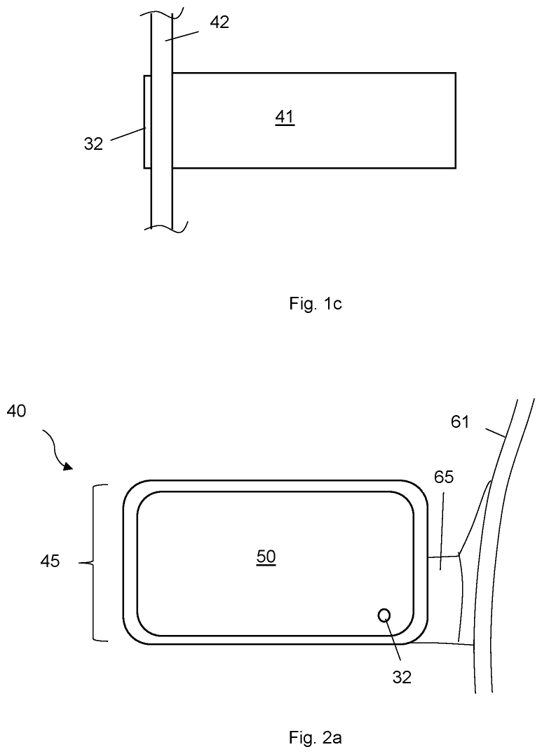

FIGS. 1a and 1b illustrate one embodiment of the disclosed system configured as a rear-view mirror. The term “rear-view mirror” as used herein refers to the primary centrally located mirror in the front windshield of a vehicle, as well as any mirror used for rear-view visibility. As shown in FIG. 1a, rear-view mirror 5 includes front face 10 comprising reflective surface 15 through which the driver can see behind the vehicle. Reflective surface 15 can be formed from various materials (such as plastic or glass) with a planar or curved front surface. Front face 10 further includes base 20 that supports the reflective surface. As shown in FIG. 1b, front face 10 is operably attached to rear body 25 to form interior 30 that houses at least one camera.

As shown in FIG. 1c, camera 81 spans at least one wall 42 of the rear-view mirror, such that camera body 41 is housed within interior 30 but camera lens 32 is present and visible on the mirror exterior. In this way, the camera can record events that occur within the vehicle. Camera lens 32 can be positioned on any desired exterior surface of the rear-view mirror 5 (e.g., base 20, reflective surface 15, and/or rear body 25). Rear-view mirror 5 can be attached to any surface (e.g., the interior surface of a vehicle windshield) using arm 35. It should be appreciated that rear-view mirror 5 is not limited to the form illustrated in FIGS. 1a and 1b, but can be configured in any of a wide variety of sizes and shapes, so long as it is capable of housing a recording device (e.g., camera and/or microphone) within interior 30.

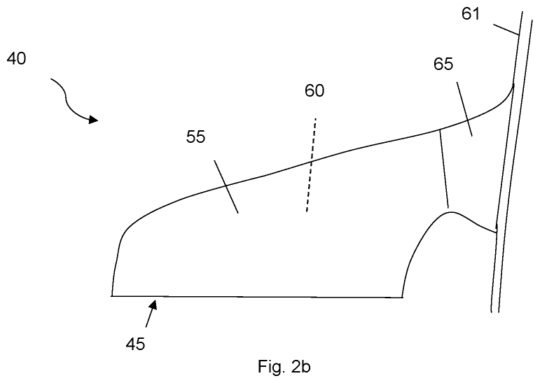

As set forth above, the disclosed recording system can also be embodied as a vehicle side-view mirror. The term “side-view mirror” refers to a vehicle mirror positioned on a side of the vehicle that enables visibility of at least a portion of the vehicle left or right side. In some embodiments, the vehicle includes side-view mirrors on both the left and right vehicle sides. FIG. 2a illustrates one embodiment of side-view mirror 40 that can house one or more recording devices as described herein. Specifically, the side-view mirror includes front face 45 comprising reflective surface 50 through which the driver can view one or both sides of the vehicle. As with the rear-view mirror, the reflective surface can be formed from any desired material that allows a driver to visualize a particular area. As shown in FIG. 2b, front face 45 is operatively attached to housing 55 to form interior 60. The mirror includes at least one camera housed within interior 60 and configured to extend through at least one wall. In this way, camera lens 32 is positioned on any exterior side view mirror surface (e.g., housing 55 and/or reflective surface 50). The side-view mirror is typically attached to surface 61 on the driver's side and/or passenger's side of the vehicle through support 65. The shape of side-view mirror 40 is not limited to the embodiment set forth in the figures. Rather, the side-view mirror can be configured in a wide variety of sizes and shapes so long as it is capable of housing a recording device and the associated electronics within interior 60.

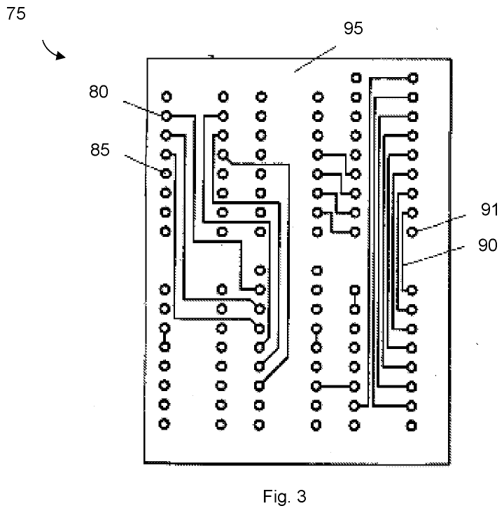

The disclosed recording system includes main board 75, which can be configured as a printed circuit board that includes all of the processing circuitry to power the disclosed system. One embodiment of main board 75 is illustrated in FIG. 3. Particularly, main board 75 can include a plurality of pads 80 and holes 85 necessary for proper connection of each system component. Pads 80 and traces 90 are printed on electrically nonconducting substrate 95. Each pad 80 and hole 85 is specifically positioned to align with and connect to a lead of a particular electronic component, or to interconnect traces 90 on different board layers. The traces interconnect leads of one component to leads of other components as required by the functioning of the particular circuit. Pads 80 are positioned around each hole 85 so that when the lead of an electronic component is inserted into the associated hole, the solder coating on the surrounding pad can electrically and mechanically connect the lead to the pad. Certain pads (e.g., pad 91) can be electronically isolated from the other pads. However, traces can also be printed on the reverse side of the board to appropriately connect such apparently isolated pads.

Main board 75 supports one or more cameras that are mounted within the mirror interior. Particularly, the main body of the camera and the electrical connections can be housed within the mirror interior, but camera lens 31 is positioned on an external mirror surface to record events. The disclosed device can include a plurality of cameras to provide multiple images that can be shown on a screen to monitor multiple areas. In some embodiments, the camera can include motion sensing characteristics to activate recording once motion is detected. In some embodiments, the camera has a plurality of LED fill lights to provide a photographic fill light function for evening or dark environments. Alternatively, the camera can have night vision capabilities.

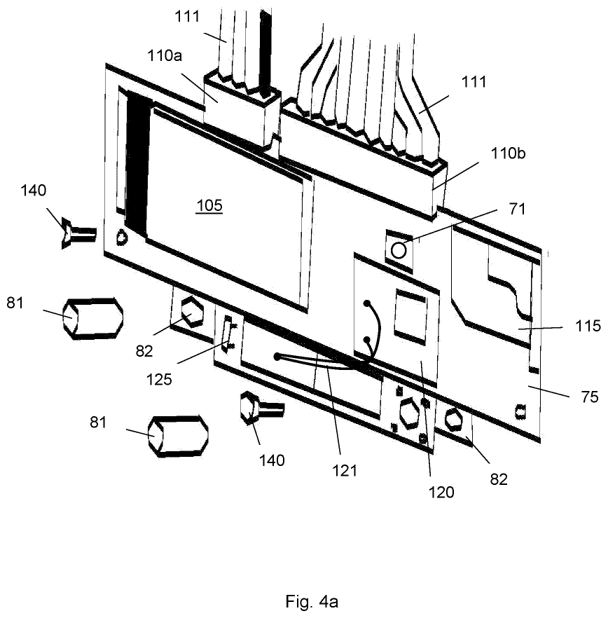

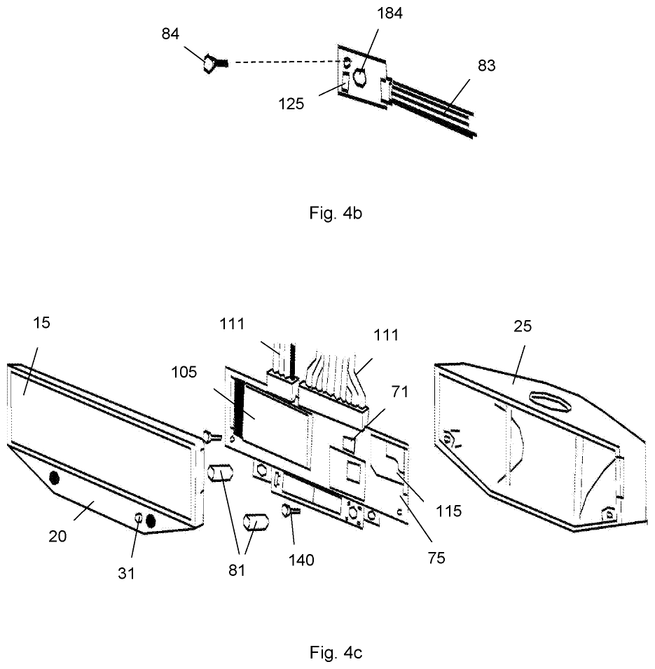

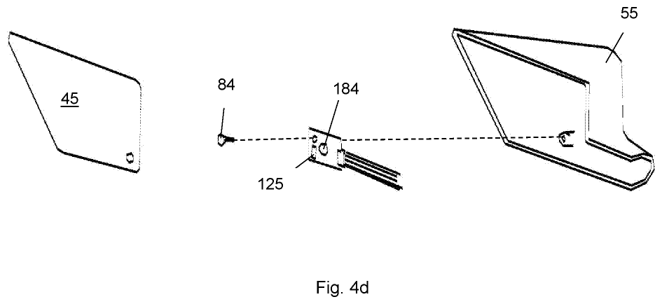

FIG. 4a illustrates one embodiment of a recording system main board. Specifically, main board 75 comprises an electronic circuit (not shown in great detail) with integrated circuits, active and passive switch elements, and the necessary conductive pathways as well as conductors for conducting signals to and from the recording system and for supplying power. As shown, the system includes one or more cameras 81 that are capable of recording incidents such as break-ins, accidents, car jackings, and the like. The camera is passed through and out of a through hole formed on a surface of one or more rear-view or side-view mirrors for capturing an image signal outside or inside a vehicle. In other words, the camera lens is mounted onto the mirror and the camera body is entirely encased within the mirror interior. The camera lens can have a separate housing for this purpose. Camera 81 can include any known appropriately sized camera, such as (but not limited to) pinhole cameras capable of capturing at least 30 frames per second. The disclosed system can include any desired number of cameras 81. For example, each mirror can include 1-5 cameras housed within the mirror interior, although any desired number of cameras can be used. Each camera lens 32 is allocated to display a predetermined surrounding.

The camera video can be processed (i.e., compressed) for transmission (streaming as data) wirelessly. For example, video can be transmitted from a camera to a portable hand-held device (such as a smartphone) via a Bluetooth™ connection or over a wireless data network. For example, the system can include Wi-Fi/Bluetooth™ card 120 and antenna 121 that allow the disclosed system to connect to another device (e.g., a user's phone, computer, or monitoring system). Although Bluetooth™ is a current wireless standard that can enable communication of video between devices, other wireless standards known in the art can be used.

In some embodiments, the system can include SD and/or microSD port 115 for data storage and/or retrieval. The system can include a USB port to connect to smart devices if the wireless network is unavailable.

Power source 105, which can be configured as a rechargeable battery or replaceable battery, can also be integrated within the system to power cameras 81. The power source can function to keep the system working without draining the vehicle battery. Power source 105 can include any known power source, such as (but not limited to) lithium-ion batteries, lithium-ion polymer batteries, nickel-cadmium batteries, nickel-metal hydride batteries, and the like. In some embodiments, the power source can have a voltage of about 1-10 volts (e.g., 1, 2, 3, 4, 5, 6, 7, 8, 9, or 10V).

At least one surface of mirrors 5, 40 can include an optional quick record feature, configured as initiator 31 that a user can press to initiate recording of the camera(s). The initiator can include light indicator 71 that allows the user to begin recoding and saving data for a predetermined amount of time. The light indicator provides notification to the user that recording is in progress. Alternatively, the light indicator can indicate an error in the system. The system can include a motion detector and moving sensor that keeps the camera at a low powered state when the engine is not running.

The system can include memory card 82 that controls storage of video captured from cameras 81. FIG. 4b illustrates one embodiment of memory card 82 that can be connected via attachment 83 to main board 75. The memory card can be removably attached to the disclosed system using known methods, such as the use of one or more screws 84. In some embodiments, memory card 82 can include microphone 125 to record audio from any events.

In some embodiments, main board 75 can include one or more card edge connectors with a plurality of spring contacts 111. Particularly, the main board can be pre-formed with a plurality of rectangular projecting tabs along one side having a width and height selectively sized to fit within the socket of a corresponding card-edge connector of a predetermined size. An array of contact terminals can be attached onto an edge along with the circuit traces during the circuit layout. The number of contacts depends upon the number of external board connections required. For example, first card edge connector 110a can be configured to control power and/or data from a side camera. In some embodiments, second card edge connector 110b can be configured to control power and/or data to the vehicle.

The disclosed recording system is housed within a mirror interior and is configured such that the camera lens extends through at least one surface of the mirror to capture exterior images. In some embodiments, the camera is maintained within the interior of the mirror through a housing or other formed compartment. In this way, damage to camera 81 is minimized. Main board 75 can be held in between the front and rear mirror components using any known method, such as (but not limited to) the use of screws 140. However, it should be appreciated that any known method can be used (e.g., adhesive, welding, clips, and the like).

As shown in FIGS. 4c and 4d, the front and rear portions of rear-view mirror 5 and side-view mirror 40 can be releasably attached using any known mechanism, such as (but not limited to) snap-fit attachment, screw-fit attachment, mechanical closures (e.g., screws, bolts, clips, nails, clamps, hinges), and the like. Alternatively, the front and rear portions of the mirror assemblies can be permanently attached together using any known mechanism, such as (but not limited to) the use of adhesive, welding, and the like.

The administrative control over the disclosed device is controlled by either the car computer or an associated smart device through wireless or wired connection. Having programmable buttons allows the cameras to be configured small in size and establish a connection to the internet or cloud backup services. Through the software, users can play back, capture, save, and send data to a backup device. With multiple digital displays and a storage inside the system, users can still access data if a phone breaks or gets lost. The final video format can have any known output, such as multiple screens (e.g., six screens) playing next to each other with a clear single audio feed that allows all microphones to be audible.

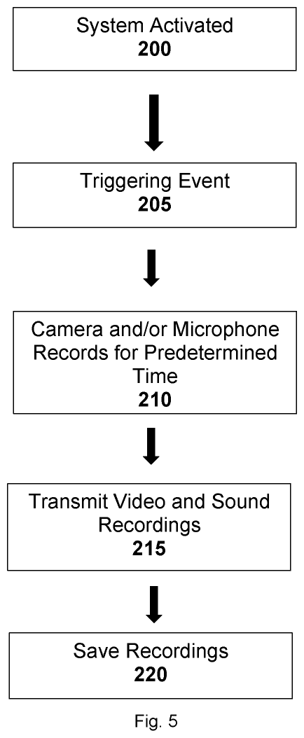

The schematic of FIG. 5 illustrates one method of using the disclosed recording system. Initially, the system is installed in a vehicle. In some embodiments, the vehicle is new. Alternatively, the vehicle can be retrofitted with the disclosed system (e.g., a rear-view mirror comprising an internal camera as described herein). The system can be activated by the user at step 200 using any known method. For example, the system can be activated by a quick record button (e.g., initiator 31), through the user's cell phone, by setting a vehicle alarm upon exit of the vehicle, and/or by inactivity monitored through camera motion detectors.

Upon the occurrence of a triggering event at step 205, the camera begins recording at step 210. The term “triggering event” refers to any event that automatically triggers the initiation of camera recording. Suitable triggering events can therefore include manual start by the user (e.g., pressing the quick record button), by a loud noise (e.g., window breaking, car crash), motion, and/or by a vehicle alarm that can optionally be built into the system. In some embodiments, cameras 81 and/or microphone 125 record for a predetermined time. In this way, audio and/or visual recordings are produced and saved by the system. The length of recording time can vary from 30 seconds to 30 minutes to 3 hours or more. In some embodiments, the user can control the length of recording time using the system settings. In other embodiments, the recording automatically stops after a set amount of time has passed with no motion (as sensed by motion detectors).

In some embodiments, the system (or vehicle) can include an alarm that sounds after the triggering event. Such alarms can include vehicle beeps, lights, etc. in an effort to deter the theft or other criminal action from progressing.

Data from the camera (and/or microphone) is then transmitted at step 215 to the user via wireless connection to the user's phone, computer, or other device. Alternatively or in addition, the police or other law enforcement authority can also be notified. In some embodiments, the data can be transmitted in real time. In some embodiments, each camera is capable of sending a unique visual image such that several views can be observed at one time.

At step 220, the system can optionally save data that has been record as a result of a triggering event, or it may be deleted. The saved recordings can be used by law enforcement to identify the perpetrator. The saved recordings can also be used in court or other criminal proceedings. Further, the recordings can be used by insurance companies to streamline claims and save time.

The disclosed system is not limited to vehicle side and rear-view mirrors. For example, in some embodiments, the system can include one or more cameras configured in a vehicle back up camera.

The disclosed system provides many benefits over the prior art. Particularly, the disclosed recording system functions to record a crime as it occurs, allowing the perpetrator to be more easily apprehended. The owner of the vehicle is immediately notified to call law enforcement.

Unlike with many other prior art systems, the driver's view through the rear-view and/or side-view mirrors is in no way obstructed by the disclosed system.

Accident investigators and insurance companies can benefit from being able to determine what happened prior to or during an accident or theft.

The disclosed system is inexpensive to install. Commonly, vehicles can easily be retrofitted with the disclosed device.

Because perpetrators are unaware of the presence of the cameras, the system is not disabled and is allowed to record the entire sequence of events.

These and other benefits would be apparent after a review of the subject disclosure and figures.

What is claimed is:

1. A vehicle recording system comprising a vehicle mirror assembly, wherein the vehicle mirror assembly is defined by:
a front face comprising a reflective material and a base that supports the reflective material;
a rear body that releasably attaches to the front face, creating an interior therebetween;
wherein the interior comprises:
at least one camera for automatically capturing an image external to the vehicle mirror, wherein each camera includes a body that is maintained within the interior and a lens that extends through the base, the front face, or the rear body to an exterior surface of the vehicle mirror;
a printed circuit board electrically coupled to the at least one camera;
a central processing unit installed on the printed circuit board and electrically coupled to the camera;
a memory installed on the printed circuit board, electrically coupled to the central processing unit for storing image data received from the camera; and
a mobile network connection module installed on the printed circuit board and electrically coupled to the central processing unit, and connected to a remote reporting data center via a signal by a wireless network signal connection.

2. The vehicle recording system of claim 1, further comprising a microphone installed on the printed circuit board, electrically coupled to the central processing unit.

3. The vehicle recording system of claim 1, wherein the front face or rear face includes an initiator that can activate recording of the at least one camera.

4. The vehicle recording system of claim 1, further comprising an indicator light visible from the exterior of the assembly to indicate when the at least one camera is recording.

5. The vehicle recording system of claim 1, wherein the camera comprises a sensor that initiates recording upon the occurrence of a triggering event.

6. The vehicle recording system of claim 5, wherein the triggering event comprises the activation of a vehicle alarm, motion detection, an increased noise level, or combinations thereof.

7. (canceled)

8. (canceled)

9. A method of recording a triggered event within a vehicle or exterior to a vehicle, the method comprising:
activating a vehicle recording system comprising a vehicle mirror assembly, the vehicle mirror assembly defined by:
a front face comprising a reflective material and a base that supports the reflective material;
a rear body that releasably attaches to the front face, creating an interior therebetween;
wherein the interior comprises:
at least one camera for automatically capturing an image external to the vehicle mirror, wherein each camera includes a body that is maintained within the interior and a lens that extends through the base, the front face, or the rear body to an exterior surface of the vehicle mirror;
a printed circuit board electrically coupled to the at least one camera;
a central processing unit installed on the printed circuit board and electrically coupled to the camera;
a memory installed on the printed circuit board, electrically coupled to the central processing unit for storing image data received from the camera; and
a mobile network connection module installed on the printed circuit board and electrically coupled to the central processing unit, and connected to a remote reporting data center via a signal by a wireless network signal connection,
initiating recording of the at least one camera to capture an area external to the mirror assembly after a triggering event occurs;
transmitting the at least one camera recording to a location; and
saving the recording;
wherein the triggered event within a vehicle or exterior to a vehicle is recorded.

10. The method of claim 9, wherein the activating is defined by activating an initiator positioned on the front face or rear face of the vehicle mirror assembly.

11. The method of claim 9, wherein the vehicle mirror assembly further includes an indicator light visible from the exterior of the assembly to indicate when the at least one camera is recording.

12. (canceled)

13. The method of claim 9, wherein the triggering event comprises the activation of a vehicle alarm, motion detection, an increased noise level, or combinations thereof.

14. The method of claim 9, wherein the transmitting comprises a wireless transmission.

15. The method of claim 9, wherein the at least one camera is hidden from view from the interior or exterior of the vehicle.

16. The method of claim 9, wherein the triggered event is a vehicle crime.

17. The method of claim 16, wherein the crime is selected from vehicle theft, car jacking, vehicle vandalism, abuse within or exterior to a vehicle, and vehicle accidents.

18. The method of claim 9, wherein the recording occurs for a predetermined amount of time.

19. The method of claim 9, wherein the transmitting location is selected from the vehicle owner's phone, computer, law enforcement, or combinations thereof.

20. The method of claim 9, wherein the recording is saved for a predetermined amount of time.

21. The vehicle recording system of claim 1, wherein each camera lens extends through the base.

22. The vehicle recording system of claim 1, wherein each camera lens extends through the front face.

23. The vehicle recording system of claim 1, wherein each camera comprises a compartment that maintains the camera body within the interior and the maintains the lens extending to the exterior surface of the vehicle mirror exterior surface.
